(19) United States
(12) Patent Application Publication
(10) Pub. No.: US 2010/0199690 A1
(43) Pub. Date: Aug. 12, 2010

(54) Refrigerator Isolation Valve

(75) Inventors: Trevor Bryan Husband, Lower Heyford (GB); Philip Alan Charles Walton, Witney (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Plc, Frimley (GB)

(21) Appl. No.: 12/638,650

(22) Filed: Dec. 15, 2009

(30) Foreign Application Priority Data
Feb. 10, 2009 (GB) 0902153.6

(51) Int. Cl. F25B 19/00; F16K 31/04; B23P 19/04

(52) U.S. Cl. 62/51.1; 62/268; 251/129.15; 29/700

(57) ABSTRACT

A cryogen vessel (12) connected to a refrigerator chamber (15) arranged to house a cryogenic refrigerator (17). A controlled valve (32) is provided between the cryogen vessel (12) and the refrigerator chamber (15), and may be used to isolate the refrigerator chamber from the cryogen vessel.

The present invention relates to actively cooled cryogen vessels, in particular such vessels provided with a removable cryogenic refrigerator. The invention will be described with particular reference to such cryogen vessels used to contain superconducting magnets for magnetic resonance imaging (MRI) systems, but the invention may be applied to actively cooled cryogen vessels used for any purpose.

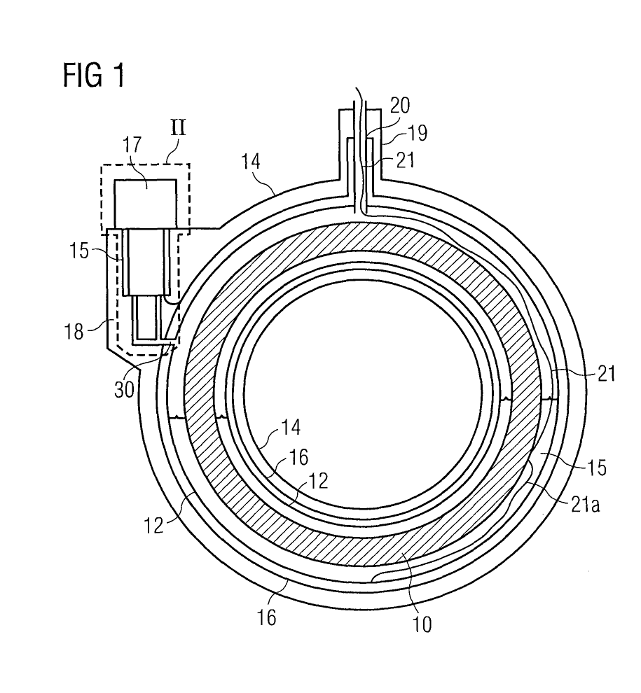

FIG. 1 shows a conventional arrangement of a cryostat including a cryogen vessel 12. A cooled superconducting magnet 10 is provided within cryogen vessel 12, itself retained within an outer vacuum chamber (OVC) 14. One or more thermal radiation shields 16 are provided in the vacuum space between the cryogen vessel 12 and the outer vacuum chamber 14. Active cooling of the cryogen vessel is provided by a cryogenic refrigerator 17. Various types of cryogenic refrigerator are known for example, Gifford-McMahon, Stirling cycle and pulse tube refrigerators. Each of these types of refrigerator is well known to those skilled in the art. The present invention is indifferent as to the type of refrigerator used, and the details of operation of the refrigerator bear no relation to the present invention, so operation of the refrigerator 17 will not be discussed in detail.

In some known arrangements, a refrigerator 17 is mounted in a refrigerator chamber 15 located in a turret 18 provided for the purpose, towards the side of the cryostat. Alternatively, refrigerator 17 may be located near the top of the cryostat. The refrigerator 17 provides active refrigeration to cool cryogen gas within the cryogen vessel 12, in some arrangements by recondensing it into a liquid. The refrigerator 17 may also serve to cool the radiation shield 16. As illustrated in FIG. 1, the refrigerator 17 may be a two-stage refrigerator. A first cooling stage is thermally linked to the radiation shield 16, and provides cooling to a first temperature, typically in the region of 80-100K. A second cooling stage provides cooling of the cryogen gas to a much lower temperature, typically in the region of 4-10K.

A negative electrical connection 21a is usually provided to the magnet 10 through the body of the cryostat. A positive electrical connection 21 is usually provided by a conductor passing through the vent tube 20.

For fixed current lead (FCL) designs, a separate vent path (auxiliary vent) (not shown in FIG. 1) is provided as a fail-safe vent in case of blockage of the vent tube 20.

In the arrangement shown in FIG. 1, the refrigerator 17 is located within a chamber 15, and the chamber is exposed to the interior of the cryogen vessel though a tube 30.

It is periodically necessary to remove the refrigerator 17 for servicing, repair or replacement. Typically, in magnet-cooling cryogen vessels, this requires current through the magnet to be removed, so called ramping-down, the refrigerator to be removed, the same refrigerator, or a replacement, replaced and current re-introduced into the magnet, so called ramping-up.

This method requires a relatively lengthy period of time during which the magnet is unavailable for use, for example for imaging patients in an MRI system and diagnosing maladies. It also represents down-time which is financially wasteful from the point of view of the system's user. Further delay is introduced by the need to check the homogeneity of the magnetic field produced, and possibly perform a shimming step, as the ramping-down and ramping-up may have had an effect on the homogeneity of the magnetic field produced. This introduces further delays and down time.

While the refrigerator is removed, there exists a direct access from the atmosphere into the cryogen vessel. This may allow air ingress into the cryogen vessel, which is most undesirable as it may lead to deposits of solidified water vapour or air within the cryogen vessel. Such deposits may block the tube 30, leading to reduced cooling efficiency, and may block a gas egress vent, which may lead to dangerously high pressures within the cryogen vessel if gas is unable to escape quickly in the case of a quench.

A quench is an event, planned or unplanned, in which a superconducting magnet suddenly ceases to be superconducting and becomes resistive. The large current flowing in the magnet heats the resistive coil, and the energy formerly stored in the magnetic field is released as heat, boiling the cryogen. Provision must be made for large volumes of gas to escape in the case of a quench. Even so, gas pressure within the cryogen vessel rises markedly during a quench.

It would be beneficial to be able to remove and replace the refrigerator 17 without having to ramp the magnet 10 down, and without exposing the interior of the cryogen vessel 12 to atmosphere. By not exposing the interior of the cryogen vessel 12 to atmosphere, the possibility of air ingress would be removed. By avoiding the need for ramping-down, time is saved, along with the need to provide a suitable power supply and shimming tools on site.

It is currently not safe to exchange the refrigerator whilst the magnet is at field, as there is a direct path from the refrigerator chamber 15 into the helium vessel. If the magnet quenches while the refrigerator is removed, cryogen gas will be blown out of the cryogen vessel. Typically, for present superconducting magnets in MRI systems, the cryogen used is helium, at a temperature of 4K. The sudden increase in pressure within the cryogen vessel during a quench would lead to a sudden increase in helium gas being blown through the tube 30 and out of the refrigerator chamber 15. This sudden flow of helium could asphyxiate the service technician, not to mention the possibility of frost bite.

If the refrigerator were removed at field and replaced, the replacement refrigerator would be at room temperature. This would introduce a high temperature into the cryogen vessel and may itself cause a quench.

Known attempts to resolve this problem include the following. A double recondensing turret is known, and is described in WO2005116515. However, difficulties have been experienced in servicing such an arrangement, as contamination within the refrigerator chamber has been found to be difficult to remove. Some arrangements provide the refrigerator in an evacuated sleeve, arranged to cool the cryogen vessel by thermal conduction through a wall of the evacuated sleeve. There is no problem of escaping cryogen or air ingress with such arrangements, as the cryogen vessel is not opened to atmosphere by the removal of the refrigerator. Difficulties have been experienced with such arrangements in ensuring effective thermal contact between the refrigerator and the wall of the vacuum sleeve, particularly on re-installation of a serviced refrigerator. Another possible solution would be to provide the service technician with breathing apparatus, to avoid the possibility of asphyxiation. Further protective clothing would be worn to protect against frost bite. This solution increases the complexity of the task, as the technician would find the equipment very awkward to work with. Specialist training and qualification would also be required, and the manufacturer of the cryogen vessel may have little control over safe working procedures in remote locations.

The present invention addresses these problems, and provides methods and apparatus as defined in the appended claims.

In particular, the present invention provides a cryogenic valve between the refrigerator chamber and the cryogen vessel. This allows the refrigeration chamber to be isolated from the cryogen vessel for servicing, preventing any escape of cryogen gas through the refrigerator chamber towards the service technician. The valve also prevents air ingress into the cryogen vessel during servicing, and may be found useful during transport of the cryogen vessel, as it may reduce the thermal ingress through the materials of the refrigerator. On reinstallation of the refrigerator, the valve may be controlled to allow a flow of cryogen gas to escape from the cryogen vessel past the refrigerator, cooling the refrigerator and reducing the likelihood of quench.

The above, and further, objects, characteristics and advantages of the present invention will become more apparent from the following description of certain embodiments thereof, in conjunction with the accompanying drawings, wherein:

FIG. 1 shows a schematic cross-section of a conventional cryostat arrangement housing a superconductive magnet, to which the present invention may be applied;

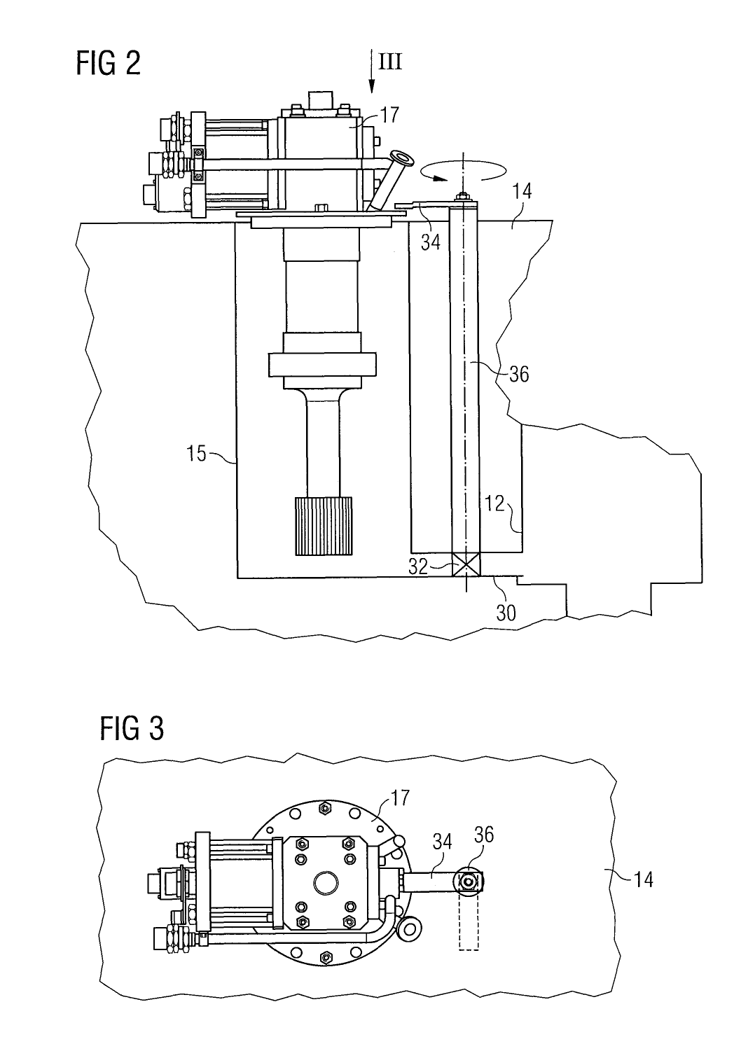

FIG. 2 shows a schematic cross-section of an example arrangement of the present invention;

FIG. 3 shows a plan view of a detail of an example arrangement of the present invention; and

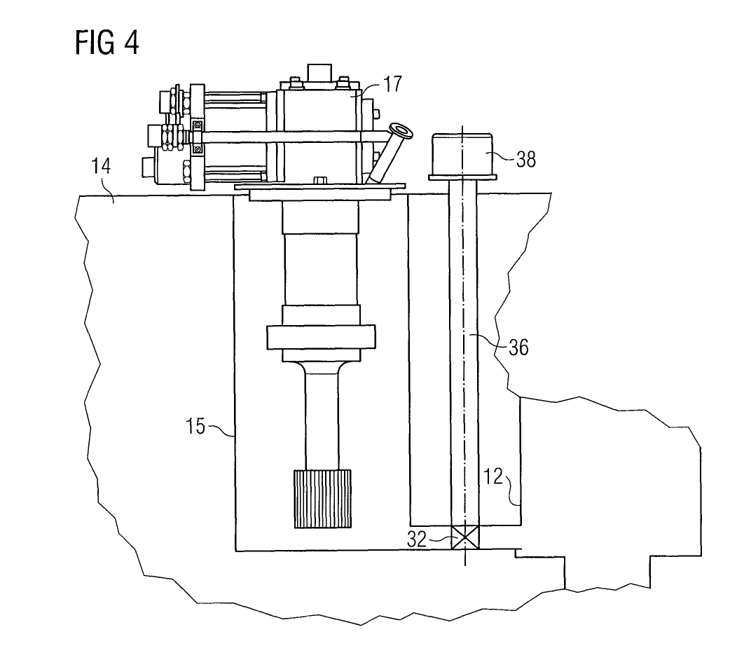

FIG. 4 shows a schematic cross-section of another example arrangement of the present invention.

FIG. 2 shows a schematic cross-section of an arrangement according to the present invention. It represents a modified enlargement of the part labelled II in FIG. 1.

As shown, a remotely controlled valve 32 is placed in the tube 30 between the cryogen vessel 12 and the refrigerator chamber 15. In this example, the valve is mechanically actuated, with a manually-activated control handle 34 connected to an operating shaft 36 which passes through the OVC 14 to be accessible to a service technician. The operating shaft 36 is preferably lengthy, as shown, to reduce the thermal load of the operating shaft on the cryogen vessel. The operating shaft is preferably of a material of low thermal conductivity, such as stainless steel or a fibre-reinforced-resin composite material.

When a service technician needs to remove the refrigerator 17 to service or replace it, the technician operates the control handle 34 to close the valve 32. This isolates the refrigerator chamber 15 from the cryogen vessel 12. The refrigerator may then be removed without opening the cryogen vessel to atmosphere. While the technician is working, there is no cryogen path from the cryogen vessel 12 to the refrigerator chamber 15. Should the magnet quench while the refrigerator is removed, the volumes of cryogen gas boiled during the quench escape from the cryogen vessel through the quench paths provided for the purpose. When the technician has replaced the refrigerator, the valve 32 is opened, and the interior of the refrigerator chamber is again exposed to the interior of the cryogen vessel. The air which was present in the refrigerator chamber may freeze into a frost on the walls of the refrigerator chamber. Preferably, however, before the valve 32 is opened, the refrigerator chamber 15 is flushed with cryogen gas at room temperature, to prevent the formation of such frost when the valve 32 is opened. Rather than opening valve 32 abruptly, the valve is preferably initially opened only partially. Cold cryogen gas is allowed to flow through the refrigerator chamber 15 and out through a valve provided for the purpose. This may serve to flush out any remaining air, and cool the refrigerator, preventing cryogen gas heated by the refrigerator from entering the cryogen vessel. Such heated cryogen gas may be enough to cause a quench if it were to reach the magnet coils.

As the technician is protected from escaping cryogen, there is no need to ramp-down the magnet, and the refrigerator removal and replacement may be carried out with the magnet at field. This makes the servicing operation must less time consuming and less costly.

Valve 32 must be of a type designed to carry cryogenic liquids at temperatures as low as 4K.

Preferably, an indicator is provided, to show the service technician whether the valve is open or closed. The technician could then be sure that the valve is closed before removing the refrigerator, and would be reminded to open the valve again once the refrigerator is replaced.

A more preferable arrangement is schematically illustrated in FIG. 3, which shows a plan view of a part of the arrangement of FIG. 2, in the direction shown by arrow III. Refrigerator 17 is shown in position, mounted to the OVC 14. Control handle 34 is shown in the position corresponding to the valve 32 being open, with its alternative position, corresponding to the valve 32 being closed, shown in phantom. As can be seen in the drawing, the size and position of the handle interact with the positioning and configuration of the refrigerator 17 to provide a mechanical safety interlock. It is not possible to remove the refrigerator when the valve 32 is opened, since the handle 34 is then overlapping part of the refrigerator preventing its removal. The service technician must move the handle 34 to its other position, corresponding to valve 32 being closed, before the refrigerator can be removed. This prevents the service technician removing the refrigerator without closing valve 32. A further mechanical interlock may be provided to prevent, or at least impede, the opening of valve 32 while the refrigerator is absent. For example, a sprung peg may be released from a cavity by the removal of the refrigerator, and may impede the motion of control handle 34. The sprung peg may be pushed back into its cavity by replacement of the refrigerator.

FIG. 4 shows a second embodiment of the present invention. Features common with FIG. 2 carry common reference numerals.

The embodiment of FIG. 4 differs from the embodiment of FIG. 2 in that the valve 32 is operated electrically. The valve may be solenoid operated, or it may be a rotary valve operated by a motor. This valve is preferably spring-loaded into a closed position, so that it rests in a normally closed position, and ensures that the valve automatically closes when power is removed. In the illustrated embodiment, the valve 32 is operated by rotation of operating shaft 36 by motor 38, for example a stepper motor. As with the embodiment of FIG. 2, the operating shaft 36 is preferably lengthy, and of a material of low thermal conductivity, such as stainless steel or fibre-reinforced resin. Heat generated by the motor will be kept away from the cryogen vessel.

Alternatively, a solenoid valve may be located within the vacuum space between the cryogen vessel 12 and the OVC 14. The power to drive the solenoid valve or motor is preferably derived from the refrigerator 17. This would mean that when the refrigerator is turned off, in preparation for removal, the valve 32 would automatically close, and allow the refrigerator to be removed safely, while the magnet is at field. The valve could not be opened again until after the refrigerator is replaced, restoring the power supply to the valve. This may be regarded as an electrical interlock, an electrical equivalent of the mechanical interlock discussed above with reference to FIG. 3.

Other arrangements may be provided for controlling operation of valve 32. The valve is operable to isolate the refrigerator chamber from the cryogen vessel. Preferably, arrangements are made to reduce the possibility of the valve 32 from being opened while the refrigerator is absent, for example by the provision of mechanical or electrical interlock.

A further advantage of the valve provided by the present invention is in that it allows the refrigerator chamber 15 to be isolated from the cryogen vessel 12 during storage and transport of the magnet. Typically, superconducting magnets for MRI systems are transported cold, that is, filled with liquid cryogen which boils off during transport. The rate of boiling of cryogen determines the length of time for which the magnet will remain cold during transport or storage, before the cryogen runs dry, in the absence of active refrigeration. The rate of boiling is essentially determined by the rate of thermal influx from ambient to the cryogen vessel. In arrangements such as shown in FIG. 1, the material of the refrigerator (typically a metal such as stainless steel) conducts heat from ambient temperature into the cryogen vessel, joined to the refrigerator chamber by tube 30. The valve 32 of the present invention may be closed during transport or storage of the magnet. This will ensure that any heat conducted through the material of the refrigerator will only heat the gas in the refrigerator chamber, which will not be able enter the cryogen vessel. This will significantly reduce thermal influx into the cryogen vessel, and increase the allowable time for transport or storage of the cold magnet. In arrangements such as discussed with reference to FIG. 4, the valve 32 should close automatically when power is removed for transport or storage of the magnet. In manually-operated valves such as shown in FIG. 2, the closing of valve 32 for storage or transport and its re-opening on arrival or re-commissioning must be instructed as part of the de-commissioning/re-commissioning process.

A further reduction in thermal influx during storage or transport would result from the removal of the refrigerator 17, and the re-sealing of the refrigerator chamber 15, for example using a blanking plate.

While the present invention has been particularly described with reference to cryogen vessels retaining superconducting magnets for MRI systems, the present invention may be applied to any actively-cooled cryogen vessel.

1. A cryogen vessel connected to a refrigerator chamber arranged to house a cryogenic refrigerator, wherein a controlled valve is provided between the cryogen vessel and the refrigerator chamber, operable to isolate the refrigerator chamber from the cryogen vessel.

2. A cryogen vessel connected to a refrigerator chamber according to claim 1, housed within an outer vacuum chamber, wherein the valve is manually operable, being connected to a control handle accessible from outside of the outer vacuum chamber for manual operation of the valve.

3. A cryogen vessel connected to a refrigerator chamber according to claim 2, provided with a mechanical interlock, arranged such that a refrigerator, once housed within the refrigerator chamber cannot be removed with the valve open.

4. A cryogen vessel connected to a refrigerator chamber according to claim 2, provided with a mechanical interlock, arranged such that the valve cannot be opened unless the refrigerator is housed within the refrigerator chamber.

5. A cryogen vessel connected to a refrigerator chamber according to claim 1, wherein the valve is electrically operable.

6. A cryogen vessel connected to a refrigerator chamber according to claim 5, wherein the valve is spring-biased to a closed position, such that the valve will be closed if no electrical supply is available.

7. A cryogen vessel connected to a refrigerator chamber according to claim 6, wherein an electrical supply to an electrical actuator of the valve is derived from the refrigerator.

8. A cryogen vessel connected to a refrigerator chamber according to claim 5, wherein the electrically operated valve is a solenoid valve.

9. A cryogen vessel connected to a refrigerator chamber according to claim 5, wherein the electrically operated valve is a rotary valve operated by an electric motor.

10. A method for installing a cryogenic refrigerator in a refrigeration chamber of a cryogen vessel connected to a refrigerator chamber according to claim 1, comprising the steps of ensuring that the controlled valve is closed before installing the refrigerator and opening the controlled valve after the refrigerator is installed.

11. A method for removing a cryogenic refrigerator from a refrigeration chamber of a cryogen vessel connected to a refrigerator chamber according to claim 1, comprising the step of closing the controlled valve before removing the refrigerator.

12. A method for preparing a cryogen vessel connected to a refrigerator chamber according to claim 1 for transport or storage, comprising the step of ensuring that the controlled valve is closed.

13. A cryogen vessel connected to a refrigerator chamber according claim 3, provided with a mechanical interlock, arranged such that the valve cannot be opened unless the refrigerator is housed within the refrigerator chamber.

14. A cryogen vessel connected to a refrigerator chamber according to claims 6, wherein the electrically operated valve is a solenoid valve.

15. A cryogen vessel connected to a refrigerator chamber according to claims 7, wherein the electrically operated valve is a solenoid valve.

16. A cryogen vessel connected to a refrigerator chamber according to claim 6, wherein the electrically operated valve is a rotary valve operated by an electric motor.

17. A cryogen vessel connected to a refrigerator chamber according to claim 7, wherein the electrically operated valve is a rotary valve operated by an electric motor.
